(19) United States
(12) Patent Application Publication
(10) Pub. No.: US 2025/0391850 A1
(43) Pub. Date: Dec. 25, 2025

(54) ELECTRODE, ENERGY STORAGE DEVICE, AND ENERGY STORAGE APPARATUS

(71) Applicant: GS Yuasa International Ltd., Kyoto-shi, Kyoto (JP)

(72) Inventor: Daisuke Endo, Kyoto (JP)

(21) Appl. No.: 19/108,020

(22) PCT Filed: Aug. 30, 2023
(86) PCT No.: PCT/JP2023/031362

§ 371 Date: Feb. 28, 2025

(30) Foreign Application Priority Data
Sep. 7, 2022 (JP) 2022-142555

(51) Int. Cl. H01M 4/36; H01G 11/36; H01G 11/50; H01M 4/58; H01M 4/587; H01M 4/62; H01M 50/209

(52) U.S. Cl. CPC H01M 4/366; H01M 4/5825; H01M 4/587; H01M 4/625; H01M 50/209; H01G 11/36; H01G 11/50

(57) ABSTRACT

An electrode according to one aspect of the present invention is a granular material in which particles containing a lithium transition metal compound having a polyanion structure are coated with a first carbon material, and includes active material particles including an amount of change in the particle size of 1.1 nm or less when pressurized from 20 mN to 100 mN, and a second carbon material.

### TECHNICAL FIELD

The present invention relates to an electrode, an energy storage device, and an energy storage apparatus.

### BACKGROUND ART

Nonaqueous electrolyte secondary batteries typified by lithium ion nonaqueous electrolyte secondary batteries are widely used in electronic devices such as personal computers and communication terminals, motor vehicles, and the like because the batteries are high in energy density. Nonaqueous electrolyte secondary batteries generally include an electrode assembly including a pair of electrodes electrically isolated by a separator, and a nonaqueous electrolyte interposed between the electrodes and are configured to be charged and discharged by transferring charge transport ions between both the electrodes. In addition, capacitors such as lithium ion capacitors and electric double layer capacitors are also widely in use as energy storage devices except for the nonaqueous electrolyte secondary batteries.

As a positive active material used in an energy storage device, a lithium transition metal compound having a polyanion structure such as lithium iron phosphate is known. Patent Document 1 describes a nonaqueous electrolyte secondary battery including a positive electrode containing lithium iron phosphate as a positive active material and a negative electrode containing graphite as a negative active material. The lithium transition metal compound having a polyanion structure is usually used in the form of a granular material coated with a carbon material from the viewpoint of electron conductivity and the like.

### PRIOR ART DOCUMENTS

### Patent Document

Patent Document 1: JP-A-2007-213961

### SUMMARY OF THE INVENTION

### Problems to be Solved by the Invention

In an energy storage device using a lithium transition metal compound having a polyanion structure as an active material, it is difficult to reduce the alternating current resistance.

The present invention has been made in view of the above circumstances, and an object of the present invention is to provide an electrode, an energy storage device, and an energy storage apparatus capable of reducing the alternating current resistance.

### Means for Solving the Problems

An electrode according to one aspect of the present invention is a granular material in which particles containing a lithium transition metal compound having a polyanion structure are coated with a first carbon material, and includes active material particles including an amount of change in the particle size of 1.1 nm or less when pressurized from 20 mN to 100 mN, and a second carbon material.

An energy storage device according to another aspect of the present invention includes the electrode.

An energy storage apparatus according to another aspect of the present invention includes: one or more energy storage devices according to another aspect of the present invention; and two or more energy storage devices.

### Advantages of the Invention

According to one aspect of the present invention, it is possible to provide an electrode, an energy storage device, and an energy storage apparatus capable of reducing the alternating current resistance.

### BRIEF DESCRIPTION OF THE DRAWINGS

FIG. 1 is a see-through perspective view illustrating an embodiment of an energy storage device.

FIG. 2 is a schematic diagram illustrating an embodiment of an energy storage apparatus including a plurality of energy storage devices.

### MODE FOR CARRYING OUT THE INVENTION

First, outlines of an electrode, an energy storage device, and an energy storage apparatus disclosed in the present specification will be described.

[1] An electrode according to one aspect of the present invention is a granular material in which particles containing a lithium transition metal compound having a polyanion structure are coated with a first carbon material, and in the active material particles, an amount of change in the particle size is 1.1 nm or less when pressurized from 20 mN to 100 mN, and a second carbon material.

The electrode according to [1] can reduce the alternating current resistance (hereinafter, also referred to as ACR). Although the reason for this is not clear, the following reason is presumed. A particle containing a conventional lithium transition metal compound having a polyanion structure is relatively brittle. Therefore, in the case of using particles containing a conventional lithium transition metal compound having a polyanion structure, the particles are greatly deformed at the time of pressing the active material layer in the producing process of the electrode, so that the adhesion between the substrate and the active material layer is deteriorated, and as a result, the interface resistance between the substrate and the active material layer increases, and the ACR of the electrode cannot be sufficiently reduced. On the other hand, it is presumed that since the active material particles included in the electrode according to [1] have a small deformation amount when pressurized, the adhesion between the substrate and the active material layer can be improved by pressing, and the ACR of the electrode can be reduced.

The measurement of the amount of change in the particle size of the active material particle is performed on the particle in a fully discharged state by the following method when the particle is incorporated into an energy storage device as a positive active material. First, the energy storage device is subjected to constant current charge with a charge current of 0.05 C until the voltage reaches an end of charge voltage under normal usage to be brought into a fully charged state. After a 30-minute pause, the nonaqueous electrolyte energy storage device is subjected to constant current discharge with a discharge current of 0.05 C to the end-of-discharge voltage (lower limit voltage) during normal usage. After the battery is disassembled to take out the positive electrode, a test battery using a metal lithium electrode as the counter electrode is assembled, constant current discharge is performed at a current value of 10 mA per 1 g of a positive composite until the positive potential reaches 2.0 V vs. Li/Li⁺, the positive electrode is adjusted to the completely discharged state. The cell is disassembled again to take out the positive electrode. An electrolyte and the like attached onto the taken out positive electrode are sufficiently washed with dimethyl carbonate and is dried at room temperature all day and night, and then the active material particle is collected. The collected active material particle is subjected to measurement. Operations from disassembly of the energy storage device to collection of the active material particle are performed in an argon atmosphere having a dew point of −60° C. or lower. The “under normal usage” means use of the energy storage device while employing charge conditions and discharge conditions recommended or specified in the energy storage device. With respect to the charge conditions, for example, when a charger for the energy storage device is prepared, the term refers to a case of using the energy storage device by applying the charger.

The amount of change in the particle size of the active material particle is measured by a micro-compression test using a micro-compression testing machine (“MCT-511” manufactured by Shimadzu Corporation). As a probe, a diamond planar indenter with a diameter of 50 μm is used. One active material particle is pressurized at a probe speed of 0.134 mN/sec, and a displacement amount of the probe in a pressure range of 20 mN to 100 mN is defined as the amount of change in the particle size when pressurized from 20 mN to 100 mN. In addition, the amount of change in the particle size is measured for five active material particles, and the average value thereof is adopted. The active material particle to be measured is selected from particles with a particle size of ½ times or more and 2 times or less the average particle size of the active material particles. The “particle size” of each particle is defined as an average value of the minor axis and the major axis. The minor axis is the shortest diameter passing through the center of the minimum circumscribed circle of the particle, and the major axis is the diameter passing through the center and orthogonal to the minor axis. When there are two or more shortest diameters, the shortest diameter with the longest diameter orthogonal to the diameter is defined as the minor axis. The “average particle size” means a value at which a volume-based integrated distribution calculated in accordance with JIS-Z-8819-2 (2001) is 50% based on a particle size distribution measured by a laser diffraction/scattering method for a diluted solution obtained by diluting particles with a solvent in accordance with JIS-Z-8825 (2013).

[2] In the electrode according to [1], the second carbon material may be a carbon nanotube. The electrode according to [2] can reduce ACR and improve initial power characteristics.
[3] In the electrode according to [1] or [2], the rate of change in particle size of the active material particles when pressurized from 20 mN to 100 mN may be 0.015% or less. The electrode according to [3] can further reduce ACR. The deformation rate of the particle size is defined as a percentage of the amount of change in the particle size when pressured from 20 mN to 100 mN with respect to the average particle size of the active material particles.
[4] An energy storage device according to another aspect of the present invention includes the electrode according to any one of [1] to [3]. Since the energy storage device according to [4] includes the electrode according to any one of [1] to [3], ACR can be reduced.
[5] An energy storage apparatus according to another aspect of the present invention includes: one or more energy storage devices according to the above-mentioned item [4]; and two or more energy storage devices. Since the energy storage apparatus according to [5] includes one or more energy storage devices according to [4], the initial power can be increased.

An electrode, a method for producing the electrode, an energy storage device, an energy storage apparatus, a method for producing the energy storage device, and other embodiments according to one embodiment of the present invention will be described in detail. It is to be noted that the names of the respective constituent members (respective constituent elements) for use in the respective embodiments may be different from the names of the respective constituent members (respective constituent elements) for use in the background art.

### <Electrode>

An electrode according to one embodiment of the present invention is a granular material in which particles containing a lithium transition metal compound having a polyanion structure are coated with a first carbon material, and includes active material particles including an amount of change in the particle size of 1.1 nm or less when pressurized from 20 mN to 100 mN, and a second carbon material.

### [Active Material Particle]

The active material particle included in the electrode according to an embodiment of the present invention is a granular material in which a particle containing a lithium transition metal compound having a polyanion structure is coated with a first carbon material.

### [Lithium Transition Metal Compound Having Polyanion Structure]

Examples of the lithium transition metal compound having a polyanion structure include compounds containing an oxoacid anion (PO₄³⁻, SO₄²⁻, SiO₄⁴⁻, BO₃³⁻, VO₄³⁻, etc.), a lithium ion, and a transition metal ion. The oxoacid anion may be a condensed anion (P₂O₇⁴⁻, P₃O₁₀⁵⁻, etc.). The lithium transition metal compound having a polyanion structure may have an olivine-type crystal structure. The lithium transition metal compound having a polyanion structure is typically a polyanion compound containing a lithium element and a transition metal element, and may further contain other elements (for example, a halogen element and the like). As the transition metal element of the lithium transition metal compound having a polyanion structure, an iron element, a manganese element, a nickel element, and a cobalt element are preferable, and an iron element is more preferable. The oxoacid anion of the lithium transition metal compound having a polyanion structure is preferably a phosphate anion (PO₄³⁻).

As the lithium transition metal compound having a polyanion structure, a compound represented by the following formula (1) is preferable.

LiₐM_{b}(AO_{c})_{d}Xₑ (1)

In the formula (1), M represents at least one transition metal element. A is at least one selected from B, Al, Si, P, S, Cl, Ti, V, Cr, Mo, and W. X is at least one halogen element. a, b, c, d, and e are numbers that satisfy 0<a≤3, 0<b≤2, 2≤c≤4, 1≤d≤3, and 0≤e≤1. Each of a, b, c, d, and e may be an integer or a decimal.

M in the formula (1) is preferably any one of Fe, Mn, Ni, and Co, or a combination of any two thereof. M is further preferably Fe, Mn, or a combination thereof, and more preferably Fe. In addition, the content of Fe in M is preferably 50 mol % or more, more preferably 70 mol % or more, 90 mol % or more, or 99 mol % or more. Ais preferably P. X is preferably F. As an embodiment, a=1, b=1, c=4, d=1, and e=0 may be preferable.

Specific examples of the lithium transition metal compound having a polyanion structure include LiFePO₄, LiCoPO₄, LiFe_{0.5}Co_{0.5}PO₄, LiMnPO₄, LiNiPO₄, LiMn_{0.5}Fe_{0.5}PO₄, LiCrPO₄, LiFeVO₄, Li₂FeSiO₄, Li₂Fe₂(SO₄)₃, LiFeBOs, LiFePO_{3.9}F_{0.2}, Li₃V₂(PO₄)₃, Li₂MnSiO₄, and Li₂CoPO₄F. Some of atoms or polyanions in the lithium transition metal compound having a polyanion structure may be partially substituted with other atoms or anion species. One of the lithium transition metal compound having a polyanion structure may be used singly, or two or more thereof may be used in mixture.

The content of the lithium transition metal compound having a polyanion structure in the particle containing the lithium transition metal compound having a polyanion structure may be 60% by mass or more, 80% by mass or more, 90% by mass or more, 95% by mass or more, or 99% by mass or more.

The particle containing the lithium transition metal compound having a polyanion structure may be a particle in which a plurality of primary particles exist alone without aggregation (single particle), but is preferably a secondary particle formed by aggregation of a plurality of primary particles. The particle is, for example, a secondary particle of the lithium transition metal compound having a polyanion structure.

### [First Carbon Material]

The particle containing the lithium transition metal compound having a polyanion structure is coated with a first carbon material to constitute the active material particle in the electrode according to an embodiment of the present invention. A part of the first carbon material may be present inside the particle containing the lithium transition metal compound having a polyanion structure. In the active material particle, there may be a portion not coated with the first carbon material (for example, a portion where the lithium transition metal compound having a polyanion structure is exposed).

Since the first carbon material coats the particle containing the lithium transition metal compound having a polyanion structure, the active material particle can exhibit sufficient electron conductivity between the particles. The first carbon material is, for example, a material having a carbon element content of 80% by mass or more and 100% by mass or less. The content of the carbon element in the first carbon material may be 90% by mass or more, or may be 95% by mass. Examples of elements other than the carbon element that may be contained in the first carbon material include an oxygen element, a hydrogen element, and a nitrogen element. Examples of the first carbon material include graphite and non-graphitic carbon.

The content of the first carbon material in the active material particle is preferably 0.1% by mass or more and 20% by mass or less, more preferably 0.2% by mass or more and 10% by mass or less, still preferably 0.3% by mass or more and 5% by mass or less, and particularly preferably 0.5% by mass or more and 2% by mass or less. When the content of the first carbon material in the active material particles is equal to or more than the lower limit, electron conductivity can be improved. When the content of the first carbon material in the active material particle is equal to or less than the above upper limit, the content of the lithium transition metal compound having a polyanion structure can be increased, and the discharge capacity per volume of the active material layer can be further increased, for example.

The total content of the lithium transition metal compound having a polyanion structure and the first carbon material in the active material particle is preferably 90% by mass or more and 100% by mass or less, and may be 95% by mass or more, 98% by mass or more, 99% by mass or more, or 99.9% by mass or more.

In addition, the lower limit of the ratio of the specific surface area of the first carbon material to the total specific surface area of the lithium transition metal compound having a polyanion structure and the first carbon material is preferably 5% and more preferably 10%. The upper limit is preferably 60% and more preferably 50%. By setting the upper and lower limits, an increase in interface resistance between the substrate and the active material layer can be suppressed, and ACR of the electrode can be reduced.

In the present invention, the “specific surface area” refers to a BET specific surface area determined by immersing a sample to be measured in liquid nitrogen, physically adsorbing nitrogen molecules on the particle surface by supplying nitrogen gas, and measuring the pressure and the adsorption amount at that time. As a specific measurement method, the amount of nitrogen adsorption [m²] with respect to the sample is determined by a one-point method. The value obtained by dividing the obtained amount of nitrogen adsorption by a mass [g] of the sample is defined as the BET specific surface area [m²/g]. The “Ratio of specific surface area of the first carbon material to total specific surface area of lithium transition metal compound having the polyanion structure and the first carbon material” is obtained by the following procedure. First, the positive electrode taken out by disassembling the nonaqueous electrolyte energy storage device brought into a completely discharged state by the same method as the measurement of the amount of change in the particle size of the active material particles described above is washed and dried as described above, and then the BET specific surface area of a granular material formed by coating the collected particle containing the lithium transition metal compound having the polyanion structure with the first carbon material is measured. Next, the first carbon material is removed by firing the granular material at 350° C. for 4 hours in an air atmosphere. Thereafter, the BET specific surface area of the particles containing the lithium transition metal compound having a polyanion structure from which the first carbon material includes been removed is measured. The BET specific surface area Bp₁ [m²/g] of the first carbon material is calculated by the following Formula 1, where the BET specific surface area of the granular material is Bp [m²/g], and the BET specific surface area of particles containing a lithium transition metal compound having a polyanion structure from which the first carbon material has been removed is Bp₂ [m²/g].

$${Bp}_{1} = Bp \cdot {Bp}_{2} \qquad ( 1 )$$

The “ratio of specific surface area of the first carbon material to total specific surface area of lithium transition metal compound having the polyanion structure and the first carbon material” can be determined by dividing the obtained Bp₁ by Bp and representing the result in 100 fractions.

### [Particle Size Change Amount, Particle Size Change Rate, and Average Particle Size of Active Material Particles]

The upper limit of the amount of change in the particle size when the active material particles are pressurized from 20 mN to 100 mN is 1.1 nm, preferably 1.0 nm, more preferably 0.9 nm, 0.7 nm or 0.5 nm, still preferably 0.4 nm or 0.2 nm. When the amount of change in the particle size is the above upper limit or less, the adhesion between the substrate and the active material layer can be improved, and the ACR of the electrode can be reduced. The lower limit of the amount of change in the particle size may be, for example, 0.001 nm, 0.01 nm, or 0.1 nm. The amount of change in the particle size may be equal to or more than any of the above lower limits and equal to or less than any of the above upper limits.

The upper limit of the rate of change in particle size when the active material particles are pressurized from 20 mN to 100 mN is preferably 0.015%, more preferably 0.013%, still preferably 0.010%, 0.008%, 0.006%, or 0.004%. When the rate of change in particle size is equal to or less than the above upper limit, the density of the active material layer can be further increased, and the discharge capacity per volume of the active material layer can be further increased. The lower limit of the rate of change in particle size may be, for example, 0.0001%, 0.001%, or 0.002%. The rate of change in particle size may be equal to or more than any of the above lower limits and equal to or less than any of the above upper limits.

The average particle size of the active material particles is preferably 0.5 μm or more and 30 μm or less, more preferably 1 μm or more and 20 μm or less, still preferably 2 μm or more and 15 μm or less, 4 μm or more and 10 μm or less, or 6 μm or more and 8 μm or less. When the average particle size of the active material particles is in the above range, the density of the active material layer can be further increased, and the discharge capacity per volume of the active material layer can be further increased. A crusher, a classifier, or the like is used to obtain the active material particle with a predetermined average particle size. Examples of the crushing method include a method of using a mortar, a ball mill, a sand mill, a vibratory ball mill, a planetary ball mill, a jet mill, a counter jet mill, a whirling airflow-type jet mill, a sieve, or the like. At the time of crushing, wet-type crushing in coexistence of water or an organic solvent such as hexane can also be used. As the classification method, a sieve, a wind classifier, or the like is used both in dry manner and in wet manner, if necessary.

### <Method for Producing Active Material Particles>

The active material particles included in the electrode according to an embodiment of the present invention can be efficiently obtained by adjusting the pH of the reaction liquid using an aqueous ammonia solution or the like when producing a hydroxide precursor in a method using a hydroxide precursor, a lithium source, and a carbon source. By such a production method, an active material particle which is spherical and whose particle shape is hardly deformed even when pressed is obtained. Hereinafter, the production method will be described in detail. However, the active material particles included in the present invention are not limited to those produced by the following production method.

First, a hydroxide precursor is obtained by a precipitation reaction between a transition metal ion and a hydroxide ion in water. Specifically, for example, a hydroxide precursor (a hydroxide of a transition metal) is obtained by adding a transition metal salt aqueous solution, a sodium hydroxide aqueous solution, and the like dropwise to water. The transition metal salt may be any salt that contains a transition metal element constituting a desired lithium transition metal compound and has water solubility, and for example, iron sulfate, iron chloride, cobalt sulfate, manganese sulfate, nickel sulfate, and the like can be used. In addition, a potassium hydroxide aqueous solution or the like can be used instead of the sodium hydroxide aqueous solution. When the transition metal salt aqueous solution, the sodium hydroxide aqueous solution, and the like are added dropwise to water, an aqueous ammonia solution or the like is further added dropwise to the reaction liquid in order to maintain the pH of water (reaction liquid) to which these aqueous solutions are added dropwise within a predetermined range. The pH of the reaction liquid is preferably in the range of 8.5 to 10.5. When the pH of the reaction liquid is out of the above range, and when an aqueous ammonia solution or the like is not added dropwise to the reaction liquid even when the pH of the reaction liquid is within the above range, the active material particle to be finally obtained tends to have a large amount of change in the particle size upon pressurization. The concentration of the aqueous ammonia solution to be added dropwise can be, for example, about 0.3 mol/dm³ or more and 1 mol/dm³ or less. The pH of the reaction liquid can be adjusted by adjusting the concentration, the amount of dropwise addition, and the like of the aqueous ammonia solution, the sodium hydroxide aqueous solution, and the like to be added dropwise. Another alkaline aqueous solution such as a hydrazine aqueous solution may be further added dropwise together with the aqueous ammonia solution. The pH of the reaction liquid can also be adjusted by the amount of other alkaline aqueous solutions added dropwise or the like.

Subsequently, the obtained hydroxide precursor, a lithium source, and a carbon source are mixed and fired in an inert atmosphere (for example, in a nitrogen atmosphere), thereby obtaining the active material particle according to an embodiment of the present invention. As the lithium source, a compound having a polyanion structure such as LiH₂PO₄, Li₃PO₄, or LiHSO₄ and containing a lithium element can be suitably used. In addition, as the lithium source, LiOH, lithium halide, or the like can be used. When the lithium source to be used is not a compound having a polyanion structure, a compound having a polyanion structure is further mixed and fired. As the compound having a polyanion structure, salts of ammonium cations and polyanions such as NH₄H₂PO₄, (NH₄)₃PO₄, (NH₄)₂HPO₄, (NH₄)₂SO₄, and NH₄VO₃ can be suitably used. As the carbon source, an organic substance such as sucrose, lactose, maltose, sucrose, polyvinyl alcohol, or ascorbic acid can be used. The firing temperature can be, for example, 500° C. or higher and 800° C. or lower.

### [Second Carbon Material]

An electrode according to an embodiment of the present invention includes the active material particles and a second carbon material. The second carbon material will be described.

The second carbon material has conductivity. Examples of the second carbon material include graphite, non-graphitic carbon, and graphene-based carbon. Examples of the non-graphitic carbon include carbon nanofibers, pitch-based carbon fibers, and carbon black. Examples of the carbon black include furnace black, acetylene black, and ketjen black. Examples of the graphene-based carbon include graphene, carbon nanotubes (CNTs), and fullerene. Examples of the shape of the second carbon material include a powdery form and a fibrous form. As the second carbon material, one of these materials may be used singly, or two or more thereof may be used in mixture. These materials may be composited and then used. For example, a composite material of carbon black and CNT may be used. Among them, acetylene black and CNT are preferable from the viewpoint of electron conductivity and coatability, and among them, CNT is preferable.

Examples of the CNT include single-walled carbon nanotubes (SWCNT) formed of one-layer graphene, multi-walled carbon nanotubes (MWCNT) formed of two or more layers (for example, 2 to 20 layers) of graphene, and the like. The structure of the CNT is not particularly limited, and may be any type such as a chiral (helical) type, a zigzag type, and an armchair type. The CNT may contain a catalyst metal (For example, Fe, Co, and a platinum group element (Ru, Rh, Pd, Os, Ir, Pt)) used for synthesis of the CNT.

The average diameter of the CNTs may be, for example, 0.3 nm or more and 100 nm or less, 0.5 nm or more and 50 nm or less, or 1 nm or more and 20 nm or less. The upper limit of the average diameter may be 10 nm, 5 nm, or 3 nm. By using CNTs having a relatively small average diameter, favorable electron conduction paths tend to be easily formed.

The average aspect ratio (average length with respect to average diameter) of the CNT is not particularly limited, but is, for example, 10 or more. The lower limit of the average aspect ratio of the CNTs may be 20, 30, 40, or 50. The upper limit of the average aspect ratio of the CNTs may be, for example, 10,000, 5,000, 2,000, 1,000, or 500. By using CNTs having a relatively high average aspect ratio, favorable electron conduction paths tend to be easily formed.

The average diameter and average aspect ratio of CNTs are average values of values measured from arbitrary 10 CNTs observed with an electron microscope.

The CNT can be obtained by, for example, a method in which a polymer is formed into a fibrous form by a spinning method or the like and heat-treated under an inert atmosphere, a vapor phase growth method in which an organic compound is reacted at a high temperature in the presence of a catalyst, or the like. Commercially available CNT can be used.

### <Configuration of Energy Storage Device>

An energy storage device according to one embodiment of the present invention includes: an electrode assembly including a positive electrode, a negative electrode, and a separator; an electrolyte; and a case that houses the electrode assembly and the electrolyte. The electrode assembly is usually a stacked type in which a plurality of positive electrodes and a plurality of negative electrodes are stacked with a separator interposed therebetween, or a wound type in which a positive electrode and a negative electrode are wound in a state of being stacked with a separator interposed therebetween. The electrolyte is present in a state of being contained in the positive electrode, the negative electrode, and the separator. The electrolyte may be a nonaqueous electrolyte. As an example of the energy storage device, a nonaqueous electrolyte secondary battery (hereinafter, also referred to simply as a “secondary battery”) in which the electrolyte is a nonaqueous electrolyte will be described.

### (Positive Electrode)

As the positive electrode provided in the energy storage device, the positive electrode described above as the electrode according to an embodiment of the present invention can be used.

The positive electrode includes a positive substrate and a positive active material layer disposed directly on the positive substrate or over the positive substrate with an intermediate layer interposed therebetween.

The positive substrate has conductivity. Whether the positive substrate has “conductivity” or not is determined with the volume resistivity of 10⁻² Ω·cm measured in accordance with JIS-H-0505 (1975) as a threshold. As the material of the positive substrate, a metal such as aluminum, titanium, tantalum, or stainless steel, or an alloy thereof is used. Among these metals and alloys, aluminum or an aluminum alloy is preferable from the viewpoints of electric potential resistance, high conductivity, and cost. Examples of the positive substrate include a foil, a deposited film, a mesh, and a porous material, and a foil is preferable from the viewpoint of cost. Accordingly, the positive substrate is preferably an aluminum foil or an aluminum alloy foil. Examples of the aluminum or aluminum alloy include A1085, A3003, A1N30, and the like specified in JIS-H-4000 (2014) or JIS-H-4160 (2006).

The average thickness of the positive substrate is preferably 3 μm or more and 50 μm or less, more preferably 5 μm or more and 40 μm or less, still preferably 8 μm or more and 30 μm or less, particularly preferably 10 μm or more and 25 μm or less. The average thickness of the positive substrate falls within the range mentioned above, thereby allowing the energy density per volume of the energy storage device to be increased while increasing the strength of the positive substrate.

The intermediate layer is a layer arranged between the positive substrate and the positive active material layer. The intermediate layer includes a conductive agent such as carbon particles, thereby reducing contact resistance between the positive substrate and the positive active material layer. The configuration of the intermediate layer is not particularly limited, and includes, for example, a binder and a conductive agent.

The positive active material layer contains the active material particles and a second carbon material. The positive active material layer contains optional components such as a positive active material other than the active material particles, a conductive agent other than the second carbon material, a binder, a thickener, and a filler as necessary.

The content of the active material particles in the positive active material layer is preferably 50% by mass or more and 99% by mass or less, more preferably 70% by mass or more and 98% by mass or less, still preferably 80% by mass or more and 95% by mass or less. The content of the active material particles falls within the range mentioned above, thereby allowing a balance to be achieved between the increased discharge capacity per volume and productivity of the positive active material layer.

The positive active material layer may further contain a positive active material other than the active material particles. As the other positive active material, various conventionally known positive active materials can be used. However, the content of the active material particles with respect to all the positive active materials (the total of the active material particles and other positive active materials) contained in the positive active material layer is preferably 90% by mass or more, more preferably 99% by mass or more, and still preferably 100% by mass. When the positive active material is substantially composed of only the active material particles as described above, the discharge capacity per volume of the positive active material layer can be further increased.

The content of the second carbon material in the positive active material layer is preferably 0.01% by mass or more and 10% by mass or less, more preferably 0.1% by mass or more and 9% by mass or less, still preferably 0.3% by mass or more and 7% by mass or less. The content of the second carbon material falls within the range mentioned above, thereby allowing the energy density and the like of the energy storage device to be increased. When the second carbon material is CNT, the content of CNT in the positive active material layer is preferably 0.01% by mass or more and 3.0% by mass or less, more preferably 0.1% by mass or more and 1.0% by mass or less, still preferably 0.3% by mass or more and 0.7% by mass or less. When the content of CNTs is in the above range, a better electron conduction path tends to be formed.

The positive active material layer may further contain a conductive agent other than the second carbon material. The other conductive agent is not particularly limited as long as it is a material including conductivity. Examples of such other conductive agents include metals and conductive ceramics. However, the content of the second carbon material with respect to all the conductive agents (the total of the second carbon material and other conductive agents) contained in the positive active material layer is preferably 90% by mass or more, more preferably 99% by mass or more, and still preferably 100% by mass. When the conductive agent is substantially composed only of the second carbon material as described above, ACR of the electrode can be reduced, initial power characteristics can be improved, and the like.

Examples of the binder include: thermoplastic resins such as fluororesins (e.g., polytetrafluoroethylene (PTFE), polyvinylidene fluoride (PVDF)), polyethylene, polypropylene, polyacryl, and polyimide; elastomers such as an ethylene-propylene diene rubber (EPDM), sulfonated EPDM, a styrene butadiene rubber (SBR), and a fluororubber; and polysaccharide polymers.

The content of the binder in the positive active material layer is preferably 1% by mass or more and 10% by mass or less, more preferably 3% by mass or more and 9% by mass or less. The content of the binder falls within the range mentioned above, thereby allowing the positive active material to be stably held.

Examples of the thickener include polysaccharide polymers such as carboxymethylcellulose (CMC) and methylcellulose. When the thickener includes a functional group that is reactive with lithium and the like, the functional group may be deactivated by methylation or the like in advance. In the case of using a thickener, the content of the thickener in the positive active material layer can be, for example, 0.1% by mass or more and 8% by mass or less, and can also be 5% by mass or less or 1% by mass or less. The technique disclosed herein can be preferably carried out in an aspect in which the positive active material layer contains no thickener.

The filler is not particularly limited. Examples of the filler include polyolefins such as polypropylene and polyethylene, inorganic oxides such as silicon dioxide, alumina, titanium dioxide, calcium oxide, strontium oxide, barium oxide, magnesium oxide and aluminosilicate, hydroxides such as magnesium hydroxide, calcium hydroxide and aluminum hydroxide, carbonates such as calcium carbonate, hardly soluble ionic crystals of calcium fluoride, barium fluoride, and barium sulfate, nitrides such as aluminum nitride and silicon nitride, and substances derived from mineral resources, such as talc, montmorillonite, boehmite, zeolite, apatite, kaolin, mullite, spinel, olivine, sericite, bentonite and mica, or artificial products thereof. In the case of using a filler, the content of the filler in the positive active material layer can be, for example, 0.1% by mass or more and 8% by mass or less, and can also be 5% by mass or less or 1% by mass or less. The technique disclosed herein can be preferably carried out in an aspect in which the positive active material layer contains no filler.

The positive active material layer may contain a typical nonmetal element such as B, N, P, F, Cl, Br, or I, a typical metal element such as Li, Na, Mg, Al, K, Ca, Zn, Ga, Ge, Sn, Sr, or Ba, and a transition metal element such as Sc, Ti, V, Cr, Mn, Fe, Co, Ni, Cu, Mo, Zr, Nb, or W as components other than the active material particle, other positive active materials, a second carbon material, the other conductive agent, a binder, a thickener, and a filler.

The lower limit of the density of the positive active material layer is preferably 1.8 g/cm³, more preferably 1.9 g/cm³, still preferably 2.0 g/cm³, and particularly preferably 2.1 g/cm³. When the density of the positive active material layer is equal to or more than the above lower limit, the discharge capacity per volume of the positive active material layer can be further increased. The upper limit of the density of the positive active material layer may be 2.6 g/cm³, 2.5 g/cm³, 2.4 g/cm³, or 2.3 g/cm³. The density of the positive active material layer may be equal to or more than any of the above lower limits and equal to or less than any of the above upper limits. The density of the positive active material layer can be adjusted by the type of active material particle, the strength of pressing when producing the positive electrode, and the like. The density of the positive active material layer is determined by dividing the mass per unit area of one positive active material layer by the average thickness of one positive active material layer.

The mass per unit area of one positive active material layer is preferably 0.3 g/cm² or more and 3 g/cm² or less, more preferably 0.5 g/cm² or more and 2 g/cm² or less, and still preferably 0.7 g/cm² or more and 1.5 g/cm² or less. When the mass per unit area of one positive active material layer is within the above range, for example, the discharge capacity of the energy storage device can be increased.

The positive electrode can be fabricated, for example, by stacking the positive active material layer along at least one surface of the positive substrate by applying a positive composite paste to the positive substrate and drying the positive composite paste. The positive composite paste contains, for example, each component constituting the positive active material layer and a dispersion medium. After the positive composite paste is applied and dried, pressing is preferably performed. By pressing, a positive active material layer having a high density can be obtained.

### (Negative Electrode)

The negative electrode includes a negative substrate and a negative active material layer disposed directly on the negative substrate or over the negative substrate with an intermediate layer interposed therebetween. The configuration of the intermediate layer is not particularly limited, and for example, can be selected from the configurations exemplified for the positive electrode.

The negative substrate has conductivity. As the material of the negative substrate, a metal such as copper, nickel, stainless steel, nickel-plated steel, or aluminum, an alloy thereof, a carbon material, or the like is used. Among these metals and alloys, the copper or copper alloy is preferable. Examples of the negative substrate include a foil, a deposited film, a mesh, and a porous material, and a foil is preferable from the viewpoint of cost. Accordingly, the negative substrate is preferably a copper foil or a copper alloy foil. Examples of the copper foil include a rolled copper foil and an electrolytic copper foil.

The average thickness of the negative substrate is preferably 2 μm or more and 35 μm or less, more preferably 3 μm or more and 30 μm or less, still preferably 4 μm or more and 25 μm or less, particularly preferably 5 μm or more and 20 μm or less. By setting the average thickness of the negative substrate to the above range, it is possible to increase the strength of the negative substrate and increase the energy density per volume of an energy storage device.

The negative active material layer includes a negative active material. The negative active material layer includes optional components such as a conductive agent, a binder, a thickener, and a filler, if necessary. Optional components such as a conductive agent, a binder, a thickener, and a filler can be appropriately selected from known components, and may be selected from the materials exemplified for the positive electrode.

The negative active material layer may contain a typical nonmetal element such as B, N, P, F, Cl, Br, and I, a typical metal element such as Li, Na, Mg, Al, K, Ca, Zn, Ga, Ge, Sn, Sr, and Ba, or a transition metal element such as Sc, Ti, V, Cr, Mn, Fe, Co, Ni, Cu, Mo, Zr, Ta, Hf, Nb, and W as a component other than the negative active material, the conductive agent, the binder, the thickener, and the filler.

The negative active material can be appropriately selected from known negative active materials. As the negative active material for a lithium ion secondary battery, a material capable of occluding and releasing lithium ions is usually used. Examples of the negative active material include metal Li; metals or metalloids such as Si and Sn; metal oxides or metalloid oxides such as a Si oxide, a Ti oxide, and a Sn oxide; titanium-containing oxides such as Li₄Ti₅O₁₂, LiTiO₂, and TiNb₂O₇; a polyphosphoric acid compound; silicon carbide; and carbon materials such as graphite and non-graphitic carbon (easily graphitizable carbon or hardly graphitizable carbon). Among these materials, graphite and non graphitic carbon are preferable. In the negative active material layer, one of these materials may be used alone, or two or more thereof may be used in mixture.

The term “graphite” refers to a carbon material in which an average grid spacing (d₀₀₂) of a (002) plane determined by X-ray diffraction before charge-discharge or in a discharged state is 0.33 nm or more and less than 0.34 nm. Examples of the graphite include natural graphite and artificial graphite. Artificial graphite is preferable from the viewpoint that a material having stable physical properties can be procured.

The term “non graphitic carbon” refers to a carbon material in which the average grid spacing (d₀₀₂) of a (002) plane determined by X-ray diffraction before charge discharge or in the discharged state is 0.34 nm or more and 0.42 nm or less. Examples of the non-graphitic carbon include hardly graphitizable carbon and easily graphitizable carbon. Examples of the non-graphitic carbon include a resin derived material, a petroleum pitch or a material derived from petroleum pitch, a petroleum coke or a material derived from petroleum coke, a plant derived material, and an alcohol-derived material.

In this regard, the “discharged state” means a state discharged such that lithium ions that can be occluded and released in association with charge-discharge are sufficiently released from the carbon material as the negative active material. For example, the “discharged state” of a half cell that includes, as a working electrode, a negative electrode containing a carbon material as a negative active material, and includes metal Li as a counter electrode is a state where the cell has an open circuit voltage of 0.7 V or higher.

The term “hardly graphitizable carbon” refers to a carbon material in which the d₀₀₂ is 0.36 nm or more and 0.42 nm or less.

The term “easily graphitizable carbon” refers to a carbon material in which the d₀₀₂ is 0.34 nm or more and less than 0.36 nm.

The negative active material is typically particles (powder). The average particle size of the negative active material can be, for example, 1 nm or more and 100 μm or less. When the negative active material is a carbon material, a titanium-containing oxide, or a polyphosphoric acid compound, the average particle size thereof may be 1 μm or more and 100 μm or less. When the negative active material is Si, Sn, an oxide of Si, an oxide of Sn, or the like, the average particle size thereof may be 1 nm or more and 1 μm or less. By setting the average particle size of the negative active material to the above-mentioned lower limit or more, the production or handling of the negative active material becomes easy. By setting the average particle size of the negative active material to the above upper limit or less, the electron conductivity of the negative active material layer is improved. A crusher, a classifier, or the like is used in order to obtain a powder with a predetermined particle size. When the negative active material is a metal such as metal Li, the negative active material layer may have the form of a foil.

The content of the negative active material in the negative active material layer is preferably 60% by mass or more and 99% by mass or less, more preferably 90% by mass or more and 98% by mass or less. The content of the negative active material falls within the range mentioned above, thereby allowing a balance to be achieved between the increased energy density and productivity of the negative active material layer.

### (Separator)

The separator can be appropriately selected from known separators. As the separator, for example, a separator composed of only a substrate layer, a separator where a heat resistant layer containing heat resistant particles and a binder is formed on one surface or both surfaces of the substrate layer, or the like can be used. Examples of the form of the substrate layer of the separator include a woven fabric, a nonwoven fabric, and a porous resin film. Among these forms, the porous resin film is preferable from the viewpoint of strength, and the nonwoven fabric is preferable from the viewpoint of liquid retaining property of the nonaqueous electrolyte. As the material for the substrate layer of the separator, for example, a polyolefin such as polyethylene or polypropylene is preferable from the viewpoint of shutdown function, and polyimide, aramid, or the like is preferable from the viewpoint of resistance to oxidative decomposition. As the substrate layer of the separator, a composite material of these resins may also be used.

The heat resistant particles contained in the heat resistant layer have preferably a mass loss of 5% or less when heated from room temperature to 500° C. in an air atmosphere of 1 atm, still preferably a mass loss of 5% or less when heated from room temperature to 800° C. Examples of materials that have a mass loss equal to or less than a predetermined value include inorganic compounds. Examples of the inorganic compound include oxides such as iron oxide, silicon oxide, aluminum oxide, titanium dioxide, zirconium oxide, calcium oxide, strontium oxide, barium oxide, magnesium oxide and aluminosilicate; nitrides such as aluminum nitride and silicon nitride; carbonates such as calcium carbonate; sulfates such as barium sulfate; hardly soluble ionic crystals such as calcium fluoride, barium fluoride, barium titanate; covalently bonded crystals such as silicon and diamond; and substances derived from mineral resources, such as talc, montmorillonite, boehmite, zeolite, apatite, kaolin, mullite, spinel, olivine, sericite, bentonite, and mica, and artificial products thereof. As the inorganic compound, simple substances or complexes of these substances may be used alone, or two or more thereof may be used in mixture. Among these inorganic compounds, silicon oxide, aluminum oxide, or aluminosilicate is preferable from the viewpoint of safety of the energy storage device.

The separator has a porosity of preferably 80% by volume or less from the viewpoint of strength, and preferably 20% by volume or more from the viewpoint of discharge performance. Here, the term “porosity” is a volume-based value, and means a value measured with a mercury porosimeter.

As the separator, a polymer gel composed of a polymer and a nonaqueous electrolyte may also be used. Examples of the polymer include a polyacrylonitrile, a polyethylene oxide, a polypropylene oxide, a polymethyl methacrylate, a polyvinyl acetate, polyvinylpyrrolidone, and a polyvinylidene fluoride. The use of the polymer gel has the effect of suppressing liquid leakage. As the separator, the polymer gel may be used in combination with the porous resin film, the nonwoven fabric, or the like described above.

### (Nonaqueous Electrolyte)

The nonaqueous electrolyte can be appropriately selected from known nonaqueous electrolytes. For the nonaqueous electrolyte, a nonaqueous electrolyte solution may be used. The nonaqueous electrolyte solution contains a nonaqueous solvent and an electrolyte salt dissolved in the nonaqueous solvent.

The nonaqueous solvent can be appropriately selected from known nonaqueous solvents. Examples of the nonaqueous solvent include cyclic carbonates, chain carbonates, carboxylic acid esters, phosphoric acid esters, sulfonic acid esters, ethers, amides, and nitriles. As the nonaqueous solvent, one obtained by substituting, with a halogen, a part of hydrogen atoms contained in these compounds may be used.

Examples of the cyclic carbonate include ethylene carbonate (EC), propylene carbonate (PC), butylene carbonate (BC), vinylene carbonate (VC), vinylethylene carbonate (VEC), chloroethylene carbonate, fluoroethylene carbonate (FEC), difluoroethylene carbonate (DFEC), styrene carbonate, 1-phenylvinylene carbonate, and 1,2-diphenylvinylene carbonate. Among these examples, EC is preferable.

Examples of the chain carbonate include diethyl carbonate (DEC), dimethyl carbonate (DMC), ethyl methyl carbonate (EMC), diphenyl carbonate, trifluoroethyl methyl carbonate, and bis(trifluoroethyl) carbonate. Among these examples, EMC is preferable.

As the nonaqueous solvent, it is preferable to use a cyclic carbonate or a chain carbonate, and it is more preferable to use a cyclic carbonate and a chain carbonate in combination. The use of the cyclic carbonate allows the promoted dissociation of the electrolyte salt to improve the ionic conductivity of the nonaqueous electrolyte solution. The use of the chain carbonate allows the viscosity of the nonaqueous electrolyte solution to be kept low. When a cyclic carbonate and a chain carbonate are used in combination, the volume ratio between the cyclic carbonate and the chain carbonate (cyclic carbonate:chain carbonate) is preferably set to, for example, a range from 5:95 to 50:50.

The electrolyte salt can be appropriately selected from known electrolyte salts. Examples of the electrolyte salt include a lithium salt, a sodium salt, a potassium salt, a magnesium salt, and an onium salt. Among these examples, a lithium salt is preferable.

Examples of the lithium salt include inorganic lithium salts such as LiPF₆, LiPO₂F₂, LiBF₄, LiClO₄, and LiN(SO₂F)₂, lithium oxalates such as lithium bis(oxalate)borate (LiBOB), lithium difluorooxalatoborate (LiFOB), and lithium bis(oxalate)difluorophosphate (LiFOP), and lithium salts including a halogenated hydrocarbon group, such as LiSO₃CF₃, LiN(SO₂CF₃)₂, LiN(SO₂C₂F₅)₂, LiN(SO₂CF₃)(SO₂C₄F₉), LiC(SO₂CF₃)₃, and LiC(SO₂C₂F₅)₃. Among these examples, an inorganic lithium salt is preferable, and LiPFe is more preferable.

The content of the electrolyte salt in the nonaqueous electrolyte solution is, under 1 atm at 20° C., preferably 0.1 mol/dm³ or more and 2.5 mol/dm³ or less, more preferably 0.3 mol/dm³ or more and 2.0 mol/dm³ or less, still preferably 0.5 mol/dm³ or more and 1.7 mol/dm³ or less, particularly preferably 0.7 mol/dm³ or more and 1.5 mol/dm³ or less. The content of the electrolyte salt falls within the range mentioned above, thereby allowing the ionic conductivity of the nonaqueous electrolyte solution to be increased.

The nonaqueous electrolyte solution may contain an additive in addition to the nonaqueous solvent and the electrolyte salt. Examples of the additive include halogenated carbonic acid esters such as fluoroethylene carbonate (FEC) and difluoroethylene carbonate (DFEC); oxalic acid salts such as lithium bis(oxalate)borate (LiBOB), lithium difluorooxalatoborate (LiFOB), and lithium bis(oxalate)difluorophosphate (LiFOP); imide salts such as lithium bis(fluorosulfonyl)imide (LiFSI); aromatic compounds such as biphenyl, alkylbiphenyl, terphenyl, partly hydrogenated terphenyl, cyclohexylbenzene, t-butylbenzene, t-amylbenzene, diphenyl ether, and dibenzofuran; partial halides of the aromatic compounds, such as 2-fluorobiphenyl, o-cyclohexylfluorobenzene, and p-cyclohexylfluorobenzene; halogenated anisole compounds such as 2,4-difluoroanisole, 2,5-difluoroanisole, 2,6-difluoroanisole, and 3,5-difluoroanisole; vinylene carbonate, methylvinylene carbonate, ethylvinylene carbonate, succinic anhydride, glutaric anhydride, maleic anhydride, citraconic anhydride, glutaconic anhydride, itaconic anhydride, cyclohexanedicarboxylic anhydride; ethylene sulfite, propylene sulfite, dimethyl sulfite, methyl methanesulfonate, busulfan, methyl toluenesulfonate, dimethyl sulfate, ethylene sulfate, sulfolane, dimethyl sulfone, diethyl sulfone, dimethylsulfoxide, diethylsulfoxide, tetramethylene sulfoxide, diphenyl sulfide, 4,4′-bis(2,2-dioxo-1,3,2-dioxathiolane, 4-methylsulfonyloxymethyl-2,2-dioxo-1,3,2-dioxathiolane, thioanisole, diphenyl disulfide, dipyridinium disulfide, 1,3-propene sultone, 1,3-propane sultone, 1,4-butane sultone, 1,4-butene sultone, perfluorooctane, tristrimethylsilyl borate, tristrimethylsilyl phosphate, tetrakistrimethylsilyl titanate, lithium monofluorophosphate, and lithium difluorophosphate. One of these additives may be used singly, or two or more thereof may be used in mixture.

The content of the additive included in the nonaqueous electrolyte solution is preferably 0.01% by mass or more and 10% by mass or less, more preferably 0.1% by mass or more and 7% by mass or less, still preferably 0.2% by mass or more and 5% by mass or less, particularly preferably 0.3% by mass or more and 3% by mass or less, with respect to the total mass of the nonaqueous electrolyte solution. The content of the additives falls within the range mentioned above, thereby making it possible to improve the capacity retention performance or cycle performance after high-temperature storage, and further improve the safety.

As the nonaqueous electrolyte, a solid electrolyte may be used, or the nonaqueous electrolyte solution and a solid electrolyte may be used in combination.

The solid electrolyte can be selected from any materials, such as lithium, sodium, and calcium, which have ionic conductivity and are solid at normal temperature (for example, 15° C. to 25° C.). Examples of the solid electrolyte include a sulfide solid electrolyte, an oxide solid electrolyte, a nitride solid electrolyte, and a polymer solid electrolyte.

Examples of the sulfide solid electrolyte include, in the case of a lithium ion secondary battery, Li₂S—P₂S₅, LiI—Li₂S—P₂S₅, and Li₁₀Ge—P₂S₁₂.

The form of the energy storage device according to the present embodiment is not particularly limited, and examples of the form include a cylindrical battery, a prismatic battery, a flat battery, a coin battery, and a button battery.

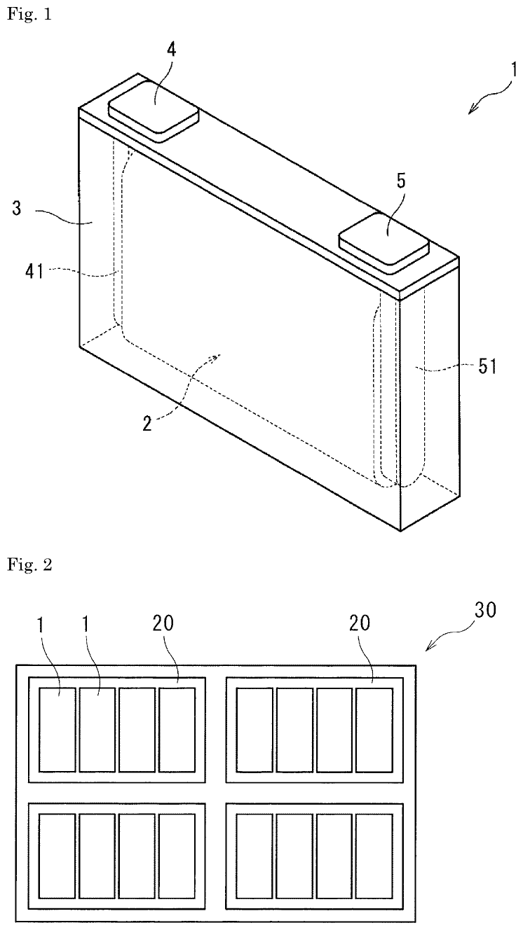

FIG. 1 illustrates an energy storage device 1 as one example of the prismatic battery. It is to be noted that FIG. 1 is a view illustrating the inside of a case in a perspective manner. An electrode assembly 2 including a positive electrode and a negative electrode wound with a separator interposed therebetween is housed in a prismatic case 3. The positive electrode is electrically connected to a positive electrode terminal 4 via a positive electrode lead 41. The negative electrode is electrically connected to a negative electrode terminal 5 via a negative electrode lead 51.

### <Configuration of Energy Storage Apparatus>

The energy storage device according to the present embodiment can be mounted as an energy storage unit (battery module), which is formed by putting together a plurality of energy storage devices, on, for example, a power source for motor vehicles such as an electric vehicle (EV), a hybrid vehicle (HEV), and a plug-in hybrid vehicle (PHEV), a power source for electronic devices such as a personal computer and a communication terminal, or a power source for power storage. In this case, the technique of the present invention may be applied to at least one energy storage device included in the energy storage unit.

An energy storage apparatus according to one embodiment of the present invention includes one or more energy storage devices according to one embodiment of the present invention and two or more energy storage devices (Hereinafter, this is referred to as a “second embodiment”). The technique according to an embodiment of the present invention may be applied to at least one energy storage device included in the energy storage apparatus according to the second embodiment, and the energy storage apparatus may include one energy storage device according to an embodiment of the present invention and include one or more energy storage devices not according to an embodiment of the present invention, or may include two or more energy storage devices according to an embodiment of the present invention.

FIG. 2 illustrates an example of an energy storage apparatus 30 according to the second embodiment, obtained by further assembling energy storage units 20 that each have two or more electrically connected energy storage devices 1 assembled. The energy storage apparatus 30 may include a busbar (not shown) that electrically connects two or more energy storage devices 1, a busbar (not shown) that electrically connects two or more energy storage units 20, and the like. An energy storage unit 20 or the energy storage apparatus 30 may include a state monitor (not illustrated) that monitors the state of one or more energy storage devices.

### <Method for Producing Energy Storage Device>

A method, according to the present embodiment, for producing an energy storage device can be appropriately selected from known methods. The producing method includes, for example, preparing an electrode assembly, preparing an electrolyte, and housing the electrode assembly and the electrolyte in a case. The preparing an electrode assembly includes: preparing a positive electrode and a negative electrode, and forming an electrode assembly by stacking or winding the positive electrode and the negative electrode with a separator interposed therebetween.

The housing the electrolyte in a case can be appropriately selected from known methods. For example, when a nonaqueous electrolyte solution is used for the electrolyte, the nonaqueous electrolyte solution may be injected from an inlet formed in the case, followed by sealing the inlet.

### OTHER EMBODIMENTS

It is to be noted that the active material particle, the electrode, and the energy storage device according to the present invention are not limited to the embodiment mentioned above, and various changes may be made without departing from the scope of the present invention. For example, to the configuration of an embodiment, the configuration of another embodiment can be added, and a part of the configuration of an embodiment can be replaced by the configuration of another embodiment or a well-known technique. Furthermore, a part of the configuration according to an embodiment can be deleted. In addition, a well-known technique can be added to a configuration of an embodiment.

In the embodiment described above, using the energy storage device as a nonaqueous electrolyte secondary battery (for example, a lithium ion secondary battery) capable of being charged and discharged has been described, but the type, form, dimensions, capacity, and the like of the energy storage device are optional. The present invention can also be applied to capacitors such as various secondary batteries, electric double-layer capacitors, or lithium ion capacitors. The energy storage device of the present invention may be an energy storage device other than the nonaqueous electrolyte energy storage device.

While the electrode assembly with the positive electrode and the negative electrode stacked with the separator interposed therebetween has been described in the embodiment mentioned above, the electrode assembly does not have to include the separator. For example, the positive electrode and the negative electrode may be brought into direct contact with each other, with a non conductive layer formed on the active material layer of the positive electrode or negative electrode.

In the above embodiment, the case where the electrode of the present invention is a positive electrode has been described, but the electrode of the present invention may be a negative electrode. The electrode of the present invention can also be used as a negative electrode by combining with a positive electrode using an appropriate positive active material.

### EXAMPLES

Hereinafter, the present invention will be described more specifically with reference to examples. The present invention is not limited to the following examples.

### Example 1

### (Preparation of Active Material Particles)

Active material particles in which secondary particles of lithium iron phosphate were coated with the first carbon material were obtained by the following procedure.

While a 1 mol/dm³ aqueous FeSO₄ solution was added dropwise at a constant rate to a 2 dm³ reaction case containing 750 cm⁸ of ion exchanged water, a 4 mol/dm³ aqueous NaOH solution, a 0.5 mol/dm³ aqueous NH₃ solution, and a 0.5 mol/dm³ aqueous NH₂NH₂ solution were added dropwise so that the pH of a reaction liquid during that time is maintained at a constant value of 8.5±0.1, thereby preparing an Fe(OH)₂ precursor. The temperature of the reaction case was set at 50° C.±2° C. Next, the prepared Fe(OH)₂ precursor was taken out from the reaction case, and solid-phase mixed with 116 parts by mass of LiH₂PO₄ and 10 parts by mass of sucrose powder based on 100 parts by mass of the Fe(OH)₂ precursor. Then, the resulting mixture was fired at a firing temperature of 650° C. under a nitrogen atmosphere to obtain active material particles of Example 1 in which particles of LiFePO₄ as a lithium transition metal compound having a polyanion structure were coated with a first carbon material.

The content of the first carbon material in the obtained active material particles of Example 1 was 1.0% by mass. The average particle size of the active material particles of Example 1 measured by the above method was 7.5 μm. When the active material particles of Example 1 were pressurized from 20 mN to 100 mN, the amount of change in the particle size was 0.2 nm, and the rate of change in particle size was 0.003%, as measured by the above method.

### (Fabrication of Positive Electrode)

A positive composite paste was prepared using the obtained active material particles, acetylene black (AB) as a second carbon material, a polyvinylidene fluoride (PVDF) as a binder, and an N-methylpyrrolidone (NMP) as a dispersion medium. A mass ratio of the active material particles, AB, and PVDF was 90:5:5 in terms of solid content. The positive composite paste was applied onto an aluminum foil that served as a positive substrate, dried, and roll-pressed to form a positive active material layer, thereby obtaining a positive electrode or Example 1. The coating amount of the positive composite paste was 1.0 g/cm² in terms of solid content, the pressure of the roll press was 320 kgf/cm, the temperature of the roll was 120° C., and the speed was 2.0 m/min.

In the obtained positive electrode of Example 1, the density of the positive active material layer measured by the above method was 2.2 g/cm³.

### (Fabrication of Negative Electrode)

Graphite as a negative active material, a styrene-butadiene rubber (SBR) as a binder, carboxymethyl cellulose (CMC) as a thickener, and water as a dispersion medium were mixed to prepare a negative composite paste. The mass ratio of graphite, SBR, and CMC was 96:3.3:0.7 in terms of solid content. The negative composite paste was applied onto a copper foil that served as a negative substrate, dried, and roll-pressed to form a negative active material layer, thereby obtaining a negative electrode.

### (Nonaqueous Electrolyte)

A nonaqueous electrolyte was obtained by dissolving LiPFe of 1.1 mol/dm³ in concentration in a solvent obtained by mixing an ethylene carbonate (EC), a diethyl carbonate (DEC), and an ethyl methyl carbonate (EMC) at volume ratios 30:35:35.

### (Separator)

As a separator, a polyethylene microporous film was used.

### (Assembly of Energy Storage Device)

The positive electrode, the negative electrode, and the separator were laminated to prepare an electrode assembly. The obtained electrode assembly was housed in a case, and then the nonaqueous electrolyte was injected into the case and then sealed to obtain an energy storage device according to Example 1.

### Examples 2 to 5 and Comparative Examples 1 to 3

Active material particles, positive electrodes, and energy storage devices of Examples 2 to 5 and Comparative Examples 1 to 3 were obtained similarly to Example 1 except that in the preparation of the active material particles, the pH of the reaction liquid and the concentration of the aqueous NH₃ solution in the production of the Fe(OH)₂ precursor were as shown in Table 1. The pH of the reaction liquid was adjusted by changing the amount of each aqueous solution to be added dropwise. In Comparative Example 3, the aqueous NH₃ solution was not added dropwise.

### Comparative Example 4

Active material particles, a positive electrode, and an energy storage device of Comparative Example 4 were obtained similarly to Example 1 except that the active material particles were prepared by the following solid phase method.

Powders of Li₂CO₃ and FePO₄, and sucrose were solid-phase mixed at a molar ratio of 1:2:1. The resulting mixture was fired at a firing temperature of 650° C. under a nitrogen atmosphere to obtain active material particles of Comparative Example 4 in which particles of LiFePO₄ as a lithium transition metal compound having a polyanion structure were coated with a first carbon material.

### Examples 6 to 10 and Comparative Examples 5 to 8

Energy storage devices of Examples 6 to 10 and Comparative Examples 5 to 8 were obtained similarly to Examples 1 to 5 and Comparative Examples 1 to 4, respectively, except that the second carbon material was CNT instead of acetylene black (AB), and the mass ratio of the active material particles, CNT and PVDF was 94.5:0.5:5 in terms of solid content.

The amount of change in the particle size (particle size change amount) of each obtained active material particle when pressurized from 20 mN to 100 mN, and the rate of change in particle size (particle size change rate) at this time are shown in Table 1.

### EVALUATION

### (Initial Charge Discharge)

Each of the obtained energy storage devices was subjected to constant current constant voltage charge at a charge current of 0.1 C and an end-of-charge voltage of 3.6 V at 25° C. With regard to the charge termination conditions, the charge was performed until the total charge time reached 15 hours. After a pause period of 10 minutes was provided, constant current discharge was performed at a discharge current of 0.1 C and an end-of-discharge voltage of 2.0 V.

### (Initial Power)

Each energy storage device after the initial charge-discharge was subjected to constant current charge at a current of 1.0 C at 25° C. to set the SOC to 50%. Subsequently, the energy storage devices were discharged at each current of 0.2 C, 0.5 C, or 1.0 C for 30 seconds. After completion of each discharge, the energy storage devices were subjected to constant current charge at a current of 1.0 C to the SOC of 50%. The relationship between the current and the voltage at 10 seconds after the start of the discharge for each discharge was plotted, and the low temperature direct-current resistance was determined from the slope of a straight line obtained from the plot of three points. Power after 10 seconds from the start of discharge was calculated from the obtained direct-current resistance and used as initial power. The results are shown in Table 1.

### (Measurement of Alternating Current Resistance)

The alternating current resistance (ACR) of 1 kHz was measured at 25° C. for each energy storage device after the initial charge discharge. The results are shown in Table 1.

TABLE 1

| | | | | Active material particle | | Positive | | |
|---|---|---|---|---|---|---|---|---|
| | Active material particle | | | Particle | Particle | electrode | | |
| | production conditions | | | size | size | Second | Evaluation | |
| | Production | | Ammonia | change | change | carbon | | Initial |
| | method | pH | concentration | amount | rate | material | ACR | power |
| | — | — | mol/dm³ | nm | % | — | mΩ | W |
| Example 1 | Via precursor | 8.5 | 0.5 | 0.2 | 0.003 | AB | 85 | 16 |
| Example 2 | Via precursor | 9.0 | 0.5 | 0.4 | 0.005 | AB | 85 | 16 |
| Example 3 | Via precursor | 9.5 | 0.5 | 0.6 | 0.008 | AB | 86 | 16 |
| Example 4 | Via precursor | 10.0 | 0.5 | 0.8 | 0.011 | AB | 86 | 15 |
| Example 5 | Via precursor | 10.5 | 0.5 | 1.0 | 0.013 | AB | 86 | 15 |
| Comparative | Via precursor | 11.0 | 0.5 | 1.2 | 0.016 | AB | 113 | 9 |
| Example 1 | | | | | | | | |
| Comparative | Via precursor | 11.5 | 0.5 | 1.5 | 0.020 | AB | 117 | 8 |
| Example 2 | | | | | | | | |
| Comparative | Via precursor | 9.0 | — | 1.3 | 0.017 | AB | 114 | 10 |
| Example 3 | | | | | | | | |
| Comparative | Solid phase | — | — | 1.2 | 0.016 | AB | 113 | 10 |
| Example 4 | method | | | | | | | |
| Example 6 | Via precursor | 8.5 | 0.5 | 0.2 | 0.003 | CNT | 85 | 19 |
| Example 7 | Via precursor | 9.0 | 0.5 | 0.4 | 0.005 | CNT | 85 | 19 |
| Example 8 | Via precursor | 9.5 | 0.5 | 0.6 | 0.008 | CNT | 86 | 19 |
| Example 9 | Via precursor | 10.0 | 0.5 | 0.8 | 0.011 | CNT | 86 | 18 |
| Example 10 | Via precursor | 10.5 | 0.5 | 1.0 | 0.013 | CNT | 86 | 18 |
| Comparative | Via precursor | 11.0 | 0.5 | 1.2 | 0.016 | CNT | 113 | 10 |
| Example 5 | | | | | | | | |
| Comparative | Via precursor | 11.5 | 0.5 | 1.5 | 0.020 | CNT | 117 | 9 |
| Example 6 | | | | | | | | |
| Comparative | Via precursor | 9.0 | — | 1.3 | 0.017 | CNT | 114 | 11 |
| Example 7 | | | | | | | | |
| Comparative | Solid phase | — | — | 1.2 | 0.016 | CNT | 113 | 11 |
| Example 8 | method | | | | | | | |

As shown in Table 1, in each of the energy storage devices of Examples 1 to 10 in which the active material particles having an amount of change in the particle size of 1.1 nm or less when the predetermined pressurization was applied were used, the ACR was reduced as compared with each of the energy storage devices of Comparative Examples 1 to 8 in which the active material particles having an amount of change in the particle size of more than 1.1 nm were used. In addition, it was found that each of the energy storage devices of Examples 6 to 10 using the CNT as the second carbon material had improved initial power characteristics as compared with each of the energy storage devices of Examples 1 to 5 using AB as the second carbon material.

### INDUSTRIAL APPLICABILITY

The present invention is suitably used as an energy storage device including a nonaqueous electrolyte secondary battery used as a power source for electronic equipment such as personal computers and communication terminals, automobiles, and the like.

### DESCRIPTION OF REFERENCE SIGNS

1: Energy storage device
2: Electrode assembly
3: Case
4: Positive electrode terminal
41: Positive electrode lead
5: Negative electrode terminal
51: Negative electrode lead
20: Energy storage unit
30: Energy storage apparatus

1. An electrode comprising:
active material particles being a granular material in which particles containing a lithium transition metal compound having a polyanion structure are coated with a first carbon material, in the active material particles, an amount of change in the particle size being 1.1 nm or less when pressurized from 20 mN to 100 mN, and
a second carbon material.

2. The electrode according to claim 1, wherein the second carbon material is a carbon nanotube.

3. The electrode according to claim 1, wherein the active material particles have a rate of change in particle size of 0.015% or less when pressurized from 20 mN to 100 mN.

4. An energy storage device comprising the electrode according to claim 1.

5. An energy storage apparatus comprising: one or more energy storage devices according to claim 4; and two or more energy storage devices.
